(19) United States
(12) Patent Application Publication
(10) Pub. No.: US 2010/0047759 A1
(43) Pub. Date: Feb. 25, 2010

(54) INDIVIDUALIZED RECURSIVE EXAM-PREPARATION-COURSE DESIGN

(76) Inventors: Steven Ma, San Jose, CA (US); Zhaohua Gan, Suunyvale, CA (US)

Correspondence Address: Clifton L. Anderson, P.O. Box 1210, Cupertino, CA, 95015, US

(21) Appl. No.: 12/195,573

(22) Filed: Aug. 21, 2008

(51) Int. Cl. G09B 7/00

(52) U.S. Cl. 434/362; 434/322

(57) ABSTRACT

A system, a method, and media provide for recursive scheduling of an exam-preparation course. The course is divided into periods. During each period, a subset of the topics for the exam subject matter is selected for study as a function of the student's performance on diagnostic exam. The periods are scheduled as a function of the student's performance profile and the time available before the target exam.

### BACKGROUND OF THE INVENTION

The present invention provides a course design for students preparing to take a college admissions or other subject-matter examination, for example, an SAT II Chemistry exam. An effective course should meet the needs of a range of students including: 1) those who have mastered the subject matter, but perform poorly under pressure; 2) students who are weak in some or all subject matter topics; 3) students who begin exam preparation with little time remaining before the exam; and 4) students enrolled in the course who fail to complete the course for whatever reason.

Consider a student that has enrolled in a comprehensive review course that covers subject matter topics in order. If the student fails to complete the course, a topic on which the student is weak may be missed; as a result, the student may perform poorly on the target exam. Even if the course is self-paced, as many on-line and media-based courses are, so that previously mastered topics can be completed quickly, the risk of omitting needed study for some topics remains.

Depending on how a course is presented, e.g., whether it is classroom-based, in a tutoring environment, on-line, media-based, paper-based (e.g., based on a textbook or study guide), etc., a student or other person such as a tutor, may adapt course material to the student's needs. While this makes the course more flexible, it removes control over course design from the course design experts. While the modifications may work in some cases, the results in general will be unpredictable. Also, since it is unlikely that the modifications will be described to the course designers, information regarding the modifications and their results are not available for the designers to use in improving an exam-preparation course. What is needed is an exam-preparation course design that pro-actively accommodates the varying needs of students and that does not unduly penalize students that start the course, but fail to finish.

Herein, related art is described to facilitate understanding of the invention. Related art labeled “prior art” is admitted prior art; related art not labeled “prior art” is not admitted prior art.

### BRIEF DESCRIPTION OF THE DRAWINGS

FIG. 1 is a schematic diagram illustrating a first iteration of an exam-preparation course design method in accordance with the present invention.

FIG. 2 is a flow chart of the method of FIG. 1 that distinguishes between first and subsequent iterations.

FIG. 3 is a schematic diagram showing the selection of topics to be studied during a period of a course scheduled in accordance with the method of FIG. 1.

FIG. 4 is a schematic diagram illustrating a second iteration of the exam-preparation course design method of FIG. 1.

FIG. 5 is a schematic diagram of a system AP1 illustrating components that implement the method of FIGS. 1.

FIG. 6 is a schematic diagram of a program of the system of FIG. 5 for implementing the method of FIGS. 1.

### DETAILED DESCRIPTION

The present invention provides a recursive test-preparation course for a target exam on a subject matter that is divided into topics. The course addresses the needs of a student who wants to achieve the highest possible score on an upcoming exam but may not have sufficient time to master the entire subject matter. The duration before the date of the target exam is divided into two or more periods (that may extend over a day, week, or month). Before each period, the student takes a diagnostic exam, from which a per-topic (e.g., per chapter) performance profile is determined. From this performance profile, a non-exhaustive subset of the subject matter topics is chosen for study. For example, the subset can consist of the student's weakest topics, as indicated by the most-recent performance profile. The topics that are weakest and therefore studied in one period may not be the weakest in the following period, nearly all topics can be studied over two or three periods.

The exam-preparation course is recursive in that the student's study is directed to achieving the maximum performance gain for each period. While the student is expected to make further gains with each successive period, the marginal benefit of study is greatest in the early periods. The present invention makes use of this fact by scheduling fewer study periods for students with limited time. Even though the total number of periods is reduced, the student typically makes better use of the available time than a student that simply omits material not reached in a linear course of study or a student that “cuts corners” on an ad hoc basis to “fit everything in”. Likewise, a student whose study is interrupted before the end of the course has received maximal marginal benefit for the studying that was done. Thus, the invention provides a test preparation course that yields maximal benefits to students given the available time.

The invention provides a computer program that tailors a course of study to a student's needs in accordance with expertise built into the program. The results of course design decisions, available in the form of diagnostic exam results as well as other results, can be fed back to the course design experts to provide for future improvements in course design. For example, gains or the lack of from one diagnostic exam to the next may indicate to a course developer that changes are needed in the algorithm used to schedule study.

Herein, certain general terms are given specific meanings for internal consistency. Most of the terminology is directed to an “exam-preparation course” for preparing a student for a “target” “exam” that covers a corresponding “subject matter”. The course typically provides for a series of diagnostic exams including an initial “diagnostic” exam as well as subsequent diagnostic exams, which can also be considered “progress” exams and may serve as “practice” exams. The subject matter can be divided into “topics” and “subtopics”. The course is divided into “periods”, which are further divided into “subperiods”. A student is assigned to study one topic per subperiod. Mastery of an individual topic is evaluated using a topic (chapter) “test”, while mastery of an individual subtopic is evaluated using a subtopic (section) “quiz”. In addition, to scheduled exams, tests, and quizzes, a student may take “drills” at any time that cover the entire subject matter.

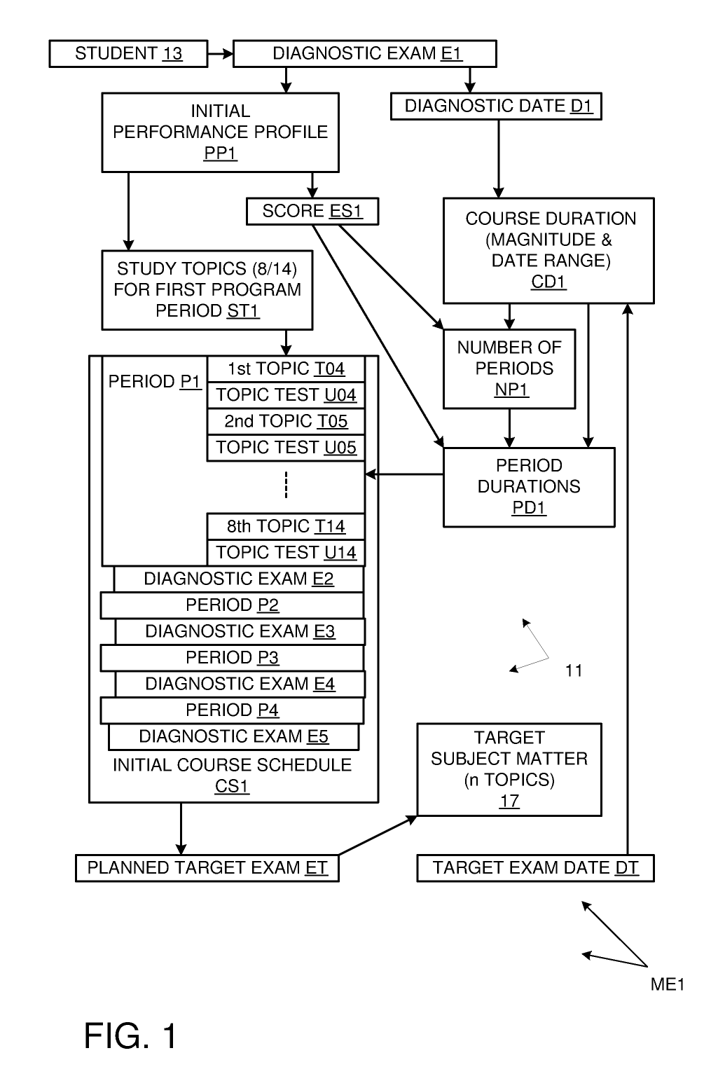

An exemplary exam-preparation course-design method ME1 of the invention provides a customized course 11 for a student 13 planning to take a target exam ET, as shown in FIG. 1. Planned target exam ET can be a college admissions exam, such as SAT II Chemistry. Planned target exam ET has an associated target subject matter 17 and a target exam date DT. Target subject matter ET can be divided into n topics (e.g., “periodic table” and “chemical kinetics and equilibrium”), wherein n is an integer.

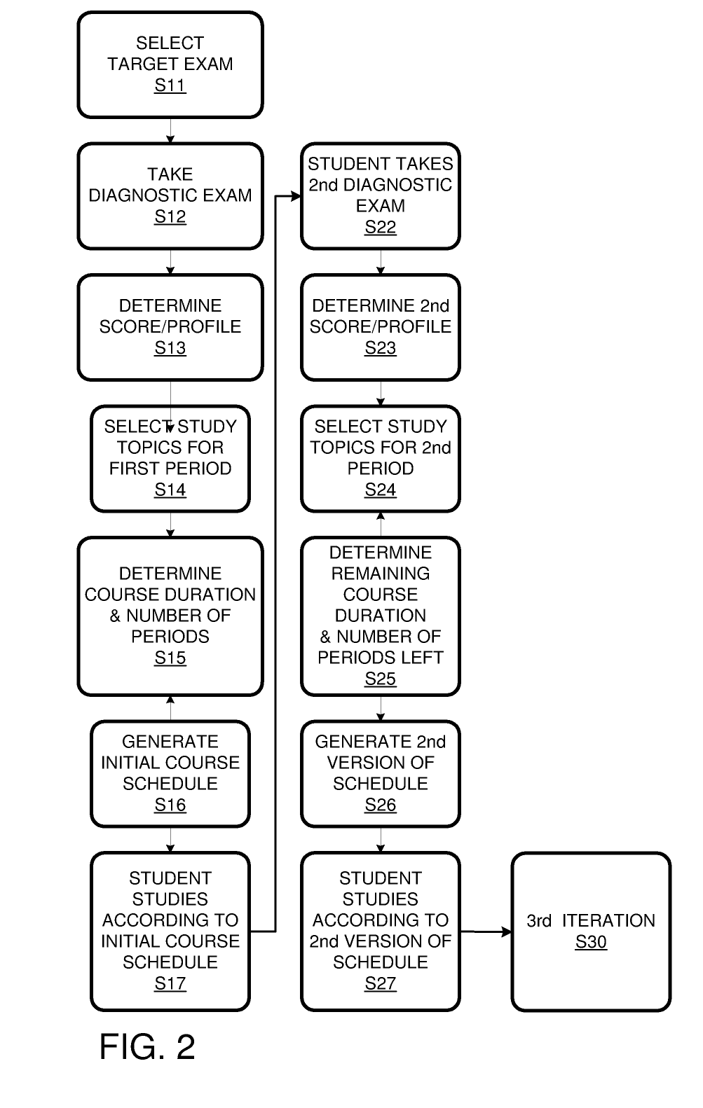

As flow-charted in FIG. 2, method ME begins with student 13 selecting a target exam at step S1, thereby defining target subject matter 17 and target exam date DT. At step S12, student 13 takes a first diagnostic exam E1, which covers the same subject matter as planned target exam ET on a first diagnostic date D1. At step S13, the results of diagnostic exam E1 are analyzed to provide a performance profile PP1, including a subject matter score ES1 as well as per-topic scores.

At step S14, the per-topics scores are used to select a set ST1 of the subject matter topics to be studied during a first period P1 of the course 11. The goal is to have the student concentrate on the topics for which study will lead to the greatest increase in expected exam score. To this end, the topics with the lowest scores on performance profile PP1 are selected for study in first period P1.

The number of topics selected is less than the number n of subject matter topics so that student 13 can focus on the topics that can provide the greatest benefit. Preferably, the number of topics selected is not many more than half the number of subject matter topics. For example, a maximum of eight topics can be selected from fourteen Chemistry topics. However, little benefit is seen for study of topics on which a student is already proficient (e.g., as indicated by 90% questions on a topic being answered correctly), so these are not selected for study. Thus, the number of topics selected for study during period P1 is the lesser of the maximum number of topics to be studied in a period (e.g., eight) and the number of topics on which student 13 is not proficient as indicated by results on diagnostic exam E1.

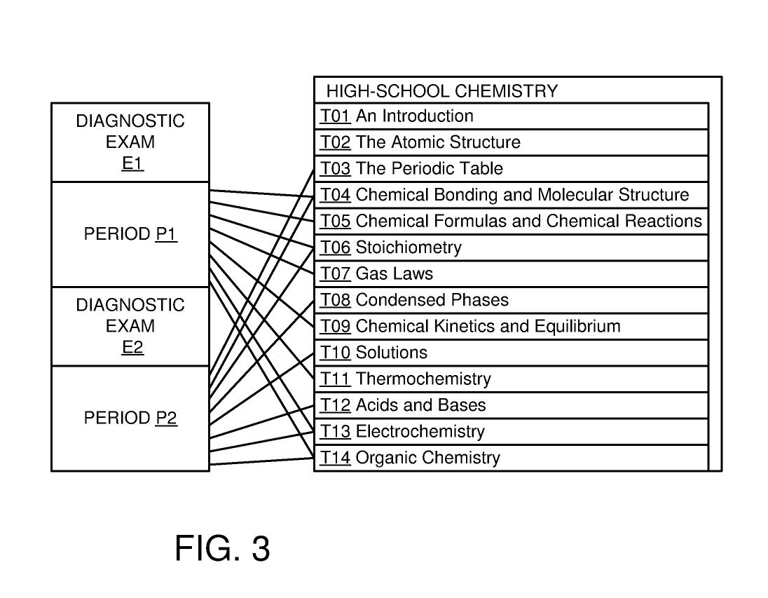

Study topics ST1 for the first period are selected from subject matter topics T01-T14, shown in FIG. 3. In the illustrated example, topics T04-T07, T09, T11, T13, and T14 are selected since the student performed least well on these as indicated on the initial diagnostic profile PP1 generated in step S13. In general, approximately half or slightly more of the topics are selected and approximately half or fewer of the topics are not selected. For example, high-school chemistry can encompass fourteen topics T01-T14, and eight are selected and the remaining six are not selected for study during first course period P1, as indicated in FIG. 3.

At step S15, the initial course duration CD1 is determined as it extends from diagnostic date D1 to target exam date DT and has a magnitude, e.g., the number of weeks between those dates. Also, a provisional number NP1 of study periods into which course duration CD1 is to be divided can be determined as a function of diagnostic exam score ES1 and the magnitude of course duration CD1. Each period P1-P4 begins and ends with a diagnostic exam E1-E5, e.g., period P1 begins with diagnostic exam E1 and ends with diagnostic exam E2.

As a practical matter, the number of periods may be limited by the number of diagnostic exams available. In practice, dividing course duration CD1 into four periods P1-P4 works for most students. Fewer periods may be recommended for students with less time before the target exam date and for students needing to emphasize study over exam practice. For some students, one period or even no periods may be scheduled (e.g., for students proficient on all subjects or course durations much less than one week). In most cases, at least two periods are scheduled so that a student can benefit from the recursive character of the course.

At step S16, an initial course schedule CS1 is generated. A period duration PD1 for period P1 is determined as a function of diagnostic score ES1, course duration CD1, and the provisional number of periods NP1 (which need not be treated separately or calculated explicitly as it is a function of diagnostic score ES1 and course duration CD1). Period duration PD1 is longer for longer course durations and lower numbers of periods NP1. In some cases, the course duration CD1 is divided evenly among period durations. However, a student who performs poorly on diagnostic exam E1 may need and will be allotted extra time for study in the first period, which can be longer than the later periods.

First period P1 is divided into subperiods, one for each topic of set ST1 selected for study during first period P1. During each subperiod, student 13 should learn from text and supplementary video presentations. Method ME1 provides a series of video presentations divided into n chapters, one chapter for each of the n subject matter topics. Each chapter is divided into sections, corresponding to subtopics for each topic. Quizzes are provided for each section (subtopic) and chapter tests are provided for each chapter. A student is required to demonstrate mastery of a topic by passing the corresponding topic test by a date on which the corresponding subperiod ends. If a student fails to demonstrate mastery in a timely manner, an email notification of that fact is sent to a responsible party, e.g., a parent or guardian. In the illustrated embodiment, period duration PD1 is divided evenly among subperiods and thus topics. In alternative embodiments, more time can be allotted to topics that involve more information or to topics needing more study as indicated by performance profile PP1.

At step S17, student 13 studies topics ST1 according to schedule CS1. This involves accessing a course website, selecting a schedule topic and following video lectures for the subtopics. Student 13 can take quizzes for each section and takes a topic test for the topic. Student 13 is required to demonstrate mastery (e.g., 80% of questions answered correctly) by the end of the topic period; otherwise, a parent is notified of the missed date.

At step S22 (so numbered to indicate its correspondence to step SI 2), after satisfactorily passing all the topic tests, student 13 takes a second diagnostic (first progress) exam E2. This exam mimics conditions of the target exam to provide practice; in addition, the results indicate how well the student is progressing.

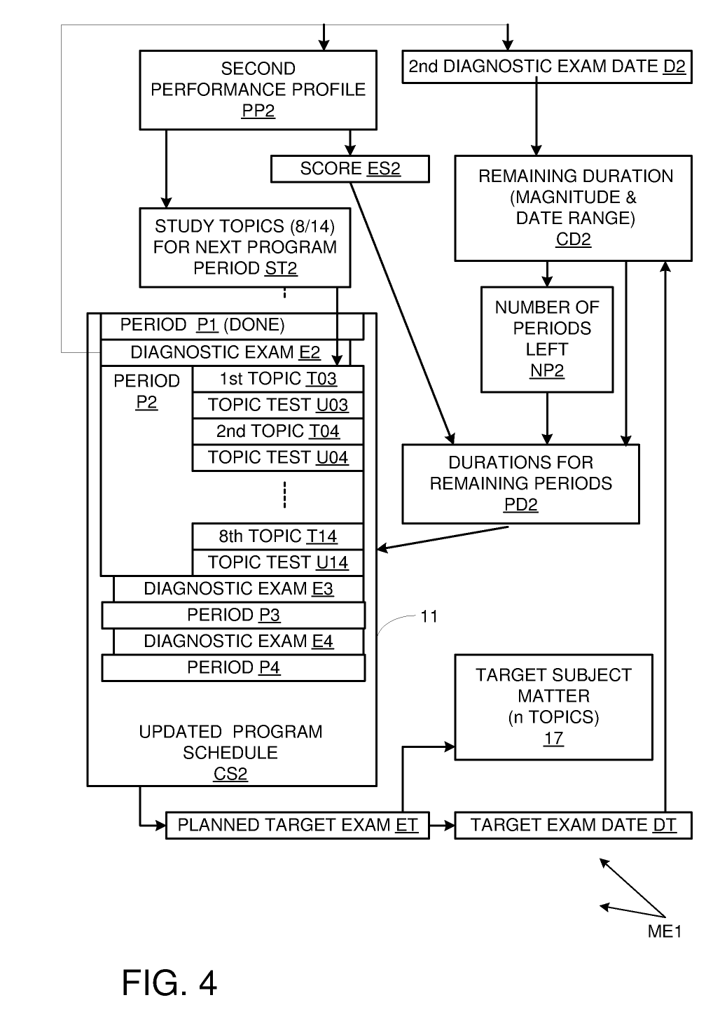

At step S23, the results of diagnostic exam E2 are analyzed to provide a second performance profile PP2 (FIG. 4) with a second overall score ES2 for student 13. At step S24, a new set ST2 of topics is chosen for study in period P2. The new set may include all new topics, all the same topics as selected for the previous period, or the topic sets selected for the two periods can overlap. Overlap (or equivalence) is the most likely case and a necessary case where more than half the available topics are selected each period. However, if the study during the preceding period did not result in sufficient gains, the previous set of topics may be selected again for the current period.

At step 25, the number of periods left NP2 and the remaining course duration PD2 are determined. In general, the number of periods remaining will be NP2=NP1−1. However, a different number of periods may be determined depending on 1) performance profile PP2, and 2) a lower than expected remaining course duration, e.g., because a student finishes the first period late.

At step S26, a second version CS2 of the course schedule is generated as a function of 1) a second performance profile PP2 from the second diagnostic exam score TS2, 2) the duration PD2 (e.g., in weeks) remaining before the target exam, and 3) the number of periods NP2 remaining. In an alternative embodiment, the number of periods remaining is not calculated and course schedules are generated as a function of performance profiles and remaining course duration. At step S27, the student studies according to the revised schedule. Upon completion of study period P2, method ME1 returns to a third iteration at step S30.

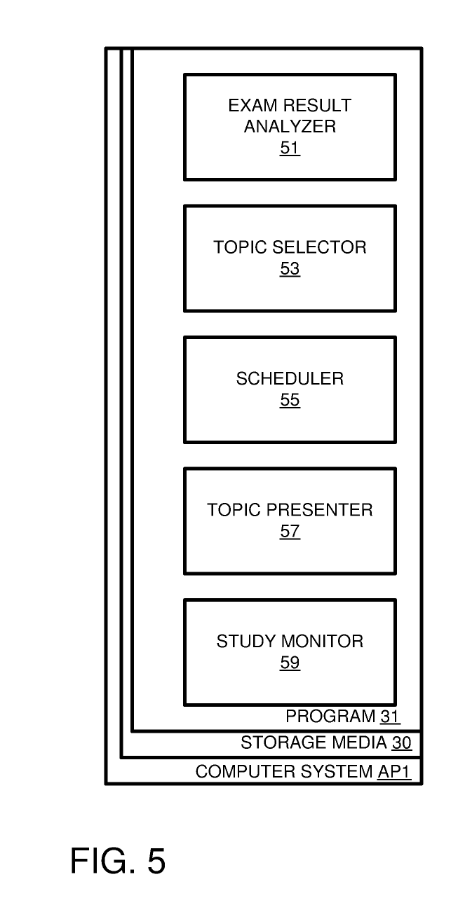

FIG. 5 shows a computer system AP1 including computer-readable storage media 30 on which a program 31 of computer-executable instructions is encoded. In the illustrated embodiment, program 31 is on a server of a course provider; student 13 accesses program 31 over the Internet. Program 31 includes an exam-result analyzer 51 for analyzing diagnostic exam results to determine exam profiles PPi, including subject matter, per-topic, and per-subtopic scores. A topic selector 53 selects topics from the subject matter topics for study during each study period. Scheduler 55 determines the number of study periods and schedules the study of the selected topics for the upcoming period. Topic presenter 57 presents selected topics in interactive sessions with the student. Study monitor 59 monitors the student's progress in a period. If the student falls behind, e.g., fails to reach 80% mastery on a topic by the scheduled deadline, study monitor 59 sends an email notification to that effect to the student's guardian.

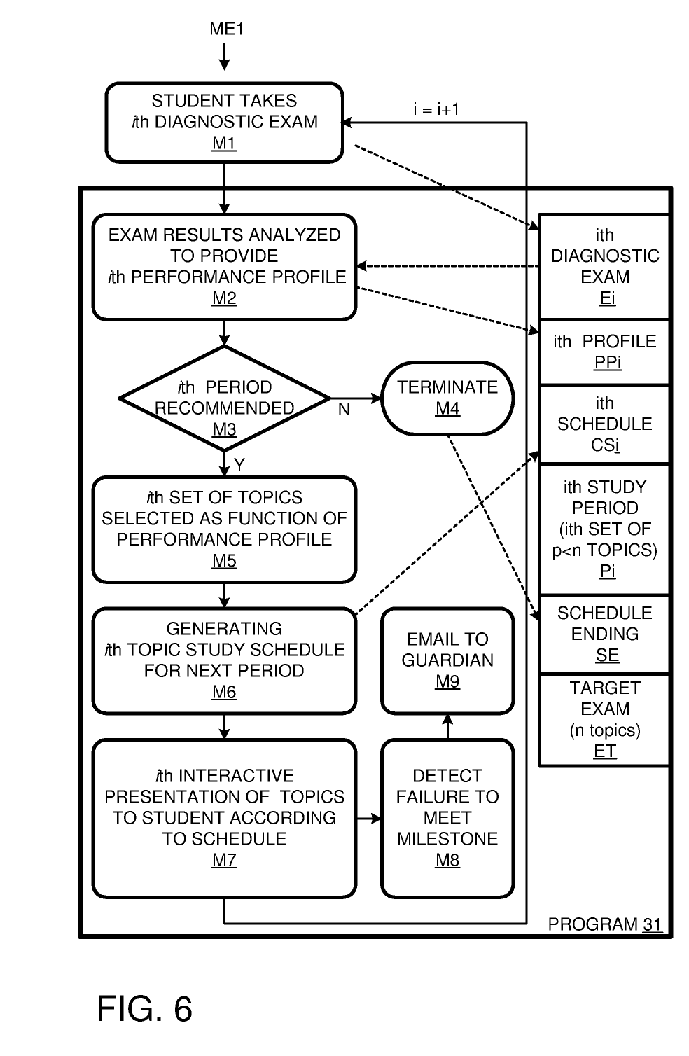

FIG. 6 presents method ME1 in a manner intended to emphasize its iterative character. When executed, program 31 implements at least part of method ME1, which can also include the student's activities. At step MI, student 13 takes an ith diagnostic exam Ei, where i is an iteration integer that begins at 1, increments each iteration (i=i+1), typically reaching some maximum value greater than or equal to 2. At step M2, program 31 analyzes the student's results for the ith diagnostic exam to generate a performance profile PPi, including an overall score and per-topic scores for all subject matter topics. For example, where the target exam is an SAT II, which provides for scores ranging from 200-800, the overall score on a diagnostic exam can be from 200-800. The per-topic scores can be in terms of percentages of questions for a topic answered correctly. In some embodiments of the invention, unanswered questions are scored differently than incorrectly answered questions.

At step M3, an ith period is either recommended or not, depending on remaining course duration and needs (as indicated by the ith performance profile. If no ith period is recommended, method ME1 terminates at step M4. The termination need not be immediate. A student may review video lectures, take remaining diagnostic exams, topic tests, subtopic quizzes, and drill on topic test questions.

If an ith period is recommended, a non-exhaustive subset included in the target subject matter is selected for study during the ith period at step M5. Preferably, the numerosity of the ith set is about or slightly more than half the number of subject matter topics. This leaves a potential for studying all topics in as few as two study periods. In the illustrated example, there are fourteen chemistry topics and eight of these are normally chosen for study per period. However, topics on which a student answered 90% questions on the ith diagnostic exam correctly are eliminated from consideration, so a high-performing student may have fewer than eight topics that require study. For most students, the number of topics to be studied per period should be between ⅓ and ⅔ of the n subject matter topics.

Once the number of topics has been determined, a schedule CSi can be generated at step M6. This involves determining a duration for the ith period as a function of the remaining course duration and ith exam score ESi; optionally, a number of remaining periods can be calculated as an intermediate variable to determine the duration for the ith period.

Schedule CSi assigns the topics selected in step M5 to respective subperiods of the ith period. The topics can be assigned to subperiods so that they are presented to the student in worst-first. In an alternative embodiment, selected topics STi are presented in logical order so that prerequisites are mastered before a topic is studied; for example, “The Atomic Structure” may be scheduled before “The Periodic Table” even if the student performed better on the former topic. The subperiods can divide the ith period evenly, or can be weighted according to the amount of material in or the students' performance on the topic in the ith diagnostic exam.

At step M7, the student takes the portion of the course scheduled for the ith period. For example, the eight topics can be assigned to eight subperiods that divide the period evenly. Each topic (chapter) can be divided into subtopics (sections). The student can take quizzes to reinforce the subtopic lessons. The student can take a topic test when the subtopics have been completed. The subtopic quizzes and topic tests are generated, e.g., randomly or based on subtopic performance, from respective pools of questions so a student can take several different quizzes for a subtopic and several different tests for a topic. Once a student meets a mastery threshold (e.g., 80% questions correctly answered) for a topic test, the student can move on to the next topic, whether or not the subperiod for the next topic is scheduled to begin.

If, however, a student fails to demonstrate mastery of a topic by the scheduled end for that topic's subperiod, this will be detected by program 31 at step M8. In response, program 31 can send an email notification to the student's guardian at step M9. Otherwise, if the student is progressing as planned, method ME1 returns to step M1 for the next iteration.

The initial and subsequent course schedules are generated using a look up table as a function of the most recent diagnostic or progress exam score, the number of periods remaining, and the magnitude of the duration remaining until the target exam. The contents of the lookup table are indicated below. The fractions are of the remaining course duration (equals the initial course duration for iteration I=1); the exam numbers correspond to the exam that ends the ith period. Test scores are on a scale from 200-800.

<=400+4˜8 weeks:
4/8 study+E2
2/8 study+E3
⅛ study+E4
⅛ study+E5
<=400+8˜12 weeks:
6/12 study+E2
3/12 study+E3
2/12 study+E4
1/12 study+E5
<=400+>12 weeks:
2/6 study+E2
2/6 study+E3
⅙ study+E4
⅙ study+E5
400˜600+<=4 weeks:
¾ study+E2
¼ study+E3
400˜600+4˜8 weeks:
4/8 study+E2
2/8 study+E3
⅛ study+E4
⅛ study+E5
400˜600+8˜12 weeks:
5/12 study+E2
4/12 study+E3
2/12 study+E4
1/12 study+E5
400˜600+>12 weeks:
4/12 study+E2
3/12 study+E3
3/12 study+E4
2/12 study+E5
600˜700+<=4 weeks:
2/4 study+E2
¼ study+E3
¼ study+E4
600˜700+4˜8 weeks:
⅜ study+E2
⅜ study+E3
⅛ study+E4
⅛ study+E5

600˜700+8˜12 weeks:
4/12 study+E2
4/12 study+E3
2/12 study+E4
2/12 study+E5
600˜700+>12 weeks:
4/12 study+E2
3/12 study+E3
3/12 study+E4
2/12 study+E5
700˜800+any number of weeks:
¼ study+E2
¼ study+E3
¼ study+E4
¼ study+E5
When students have 3 exams left:
<=400+<=4 weeks:
¾ study+E3
¼ study+E4

<=400+4˜8 weeks:
4/8 study+E3
⅜ study+E4
⅛ study+E5
<=400+8˜12 weeks:
6/12 study+E3
3/12 study+E4
3/12 study+E5
<=400+>12 weeks:
2/4 study+E3
¼ study+E4
¼ study+E5
400˜600+<=4 weeks:
¾ study+E3
¼ study+E4
400˜600+4˜8 weeks:
4/8 study+E3
⅜ study+E4
⅛ study+E5

400˜600+8˜12 weeks:
5/12 study+E3
4/12 study+E4
3/12 study+E5
400˜600+>12 weeks:
2/4 study+E3
¼ study+E4
¼ study+E5
600˜700+<=4 weeks:
2/4 study+E3
¼ study+E4
¼ study+E5
600˜700+4˜8 weeks:
4/8 study+E3
2/8 study+E4
2/8 study+E5
600˜700+8˜12 weeks:
6/12 study+E3
3/12 study+E4
3/12 study+E5

600˜700+>12 weeks:
2/4 study+E3
¼ study+E4
¼ study+E5
700˜800+any number of weeks:
⅓ study+E3
⅓ study+E4
⅓ study+E5
When students have 2 exams left: any score and any number of weeks left:
½ study+E4
½ study+E5
When students have 1 exam left:
study and take test 1 week before target date.
When students have 0 exams left:
Program will inform the student that no more exams are left, and suggest that the student practice by taking chapter tests and practice drills.

The present invention is not limited to any particular subject matter or target exam purpose or format. Diagnostic exams can be considered as part of the study periods or as occurring before, between, and after study periods. Programs embodying the invention can be implemented on a host server, on a client computer or both. The invention provides for alternative functions for scheduling study. Different numbers of periods, topics, subtopics, etc. can be selected. These and other variations upon and modifications to the illustrated embodiments are provided for by the present invention, the scope of which is defined by the following claims.

What is claimed is:

1. A method for preparing for a target exam that defines a target subject matter consisting of a set of n topics, said method comprising iterating the following sequence of steps a-d for p≧2 iterations over the integer variable i, for i equal to 1 through p:
a) a student taking an ith diagnostic exam;
b) analyzing results of said diagnostic exam to obtain an ith performance profile indicating an ith overall score and an ith set of n per-topic scores corresponding to said n topics;
c) selecting an ith subset of said set as a function of said ith profile, said ith subset including fewer than n of said topics; and
d) generating an ith study schedule for said student for an ith period of a test-preparation course, said ith schedule assigning each of the topics of said ith subset to a respective subperiod of said ith period.

2. A method as recited in claim 1 wherein said sequence further includes a step e) of presenting said ith set of topics to said student in accordance with said ith study schedule.

3. A method as recited in claim 1 wherein said ith period has an ith period duration that is a function of said ith performance profile and of a remaining course duration between an ith diagnostic date said student takes said ith diagnostic exam and a target-exam date for said target exam.

4. A method as recited in claim 1 wherein said generating involves determining an ith projected number of periods pᵢ as a function of said ith performance profile and a remaining course duration between an ith diagnostic date said student takes said ith diagnostic exam and a target-exam date for said target exam.

5. A method as recited in claim 2 wherein said ith study schedule is generated as a function of said ith performance profile, the difference pᵢ−i, and a remaining duration before a test date for said target exam.

6. A method as recited in claim 2 further comprising sending an email to a guardian of said student when said student fails to meet a predetermined performance criterion corresponding to said ith study schedule, said email being sent during said ith period.

7. A system comprising:
an exam result analyzer for analyzing the results of diagnostic exams to provide respective performance profiles for a student taken the diagnostic exams, said diagnostic exam covering a subject matter encompassing n topics;
a topic selector selecting respective non-exhaustive sets of said n topics at least in part as a function of respective ones of said performance profiles; and
a course scheduler for determining a number p≧2 of periods a course is to be divided into and for scheduling the study of a respective one of said sets of said topics to be studied during each of said periods.

8. A system as recited in claim 7 further comprising a topic presenter for presenting said topics to said student.

9. A system as recited in claim 7 further comprising a study monitor for monitoring said student's progress on each topic studied during each of said periods.

10. A system as recited in claim 9 wherein said study monitor detects when a student fails to meet a deadline of said schedule, said study monitor emailing a notification of said failure to said student's guardian.

11. Computer-readable storage media encoded with a program of computer-executable instructions, said media comprising:
an exam result analyzer for analyzing the results of diagnostic exams to provide respective performance profiles for a student taken the diagnostic exams, said diagnostic exam covering a subject matter encompassing n topics;
a topic selector for selecting non-exhaustive subsets of said n topics for study by said student; and
a course scheduler for determining a number of periods a course is to be divided into and for scheduling the study of a respective one of said subsets for each of said periods.

12. Media as recited in claim 11 further comprising a topic presenter for presenting said topics to said student.

13. Media as recited in claim 11 further comprising a study monitor for monitoring said student's progress on each topic studied during each of said periods.

14. Media as recited in claim 13 wherein said study monitor detects when a student fails to meet a deadline of said schedule, said study monitor emailing a notification of said failure to said student's guardian.
